(19) United States
(12) Patent Application Publication
(10) Pub. No.: US 2016/0242092 A1
(43) Pub. Date: Aug. 18, 2016

(54) Methods and Apparatus for Small Cell Change

(71) Applicant: NOKIA SOLUTIONS AND NETWORKS OY, Espoo (FI)

(72) Inventors: Claudio ROSA, Randers (DK); Klaus Ingemann PEDERSEN, Aalborg (DK); Benoist Pierre SEBIRE, Tokyo (JP); Chunli WU, Beijing (CN)

(21) Appl. No.: 15/024,905

(22) PCT Filed: Sep. 25, 2014
(86) PCT No.: PCT/EP2014/070497

§ 371 Date: Mar. 25, 2016

Related U.S. Application Data
(60) Provisional application No. 61/883,559, filed on Sep. 27, 2013.

(51) Int. Cl. H04W 36/30; H04W 74/08; H04W 76/02; H04W 72/04

(52) U.S. Cl. CPC H04W 36/30; H04W 72/042; H04W 74/0833; H04W 76/025

(57) ABSTRACT

Systems and techniques for changing between secondary cells in dual connectivity communication. A user device (110A) operating in dual connectivity with a master base station (102) and a source base station (106A) transmits a change request to a target secondary base station (106B), seeking a connection change to a target base station that is to be used as the secondary base station. The target base station (106B) notifies the master base station (102) of the change request, and the master base station performs changeover operations—for example, notifying the source base station (106A) that it is no longer to be used in dual connectivity with the user device (110A) making the request, and notifying the user device (110A) that the change request has been accepted, with the user device (110A) then proceeding to establish connection with the target secondary base station (106B).

### TECHNICAL FIELD

The present invention relates generally to wireless communication. More particularly, the invention relates to improved systems and techniques for changes in small cells or small base stations with dual connectivity and autonomous small cell and base station mobility.

### BACKGROUND

As the demand for wireless communication services and particularly wireless data services continues to increase, network operators are facing constraints imposed by the fact that frequency bands available for wireless communication (and, indeed, for any purpose) are finite. As demand for services increases, meeting such demand by increasing infrastructure becomes more and more difficult, even apart from the costs of deploying such infrastructure. As frequency bands become more and more saturated, interference between users competing for the same frequencies degrades service. Therefore, operators are constantly driven to increase the efficiency of their use of frequencies. One approach that is frequently used is the use of small cells defined by the coverage area of small base stations, whose range is shorter than that of larger cells. Frequencies used by small cells can be re-used even within the area defined by larger cells, because the smaller base stations will not interfere with other smaller base stations outside of their range. One approach to the use of small cells is dual connectivity, allowing a user device to connect to multiple base stations, such as a larger base station and a small base station. One approach to such dual connectivity is division of operation into a user plane and a control plane, in which user communications, that is actual voice and data communications, are managed by a small base station, while control communications are managed by a larger base station. The larger base station can provide control services to user devices within its coverage area, while the smaller base stations each provide user communication services to user devices within their control areas. Such approaches are undertaken, for example, in networks operating according to third generation partnership project (3GPP) standards, including 3GPP long term evolution (3GPP LTE) and 3GPP LTE-advanced (3GPP LTE-A) networks. Base stations in such networks may be implemented as eNodeB (eNBs) and user devices may be implemented as user equipments (UEs). The larger base stations maybe referred to as master eNBs (MeNBs) and the smaller eNBs may be referred to as secondary eNBs (SeNBs). In dual connectivity, a UE maybe simultaneously connected to an MeNB and an SeNB, with the MeNB and the SeNB connected via a backhaul link which may be referred to as an Xn interface. A frequently used scenario is one in which the MeNB and SeNBs operate on different frequency bands. In some approaches, bearer split is used. Bearer split allows the splitting of data from one radio bearer over multiple eNBs. Bearer split may also be referred to as inter-eNB carrier aggregation.

### SUMMARY

In an embodiment of the invention, an apparatus comprises at least one processor and memory storing computer program code. The memory storing the computer program code is configured to, with the at least one processor, cause the apparatus to control a user device, while in dual connectivity with a master base station and a source secondary base station, to initiate a change request to a target secondary base station and, upon receiving a change authorization from the master base station, enter into dual connectivity with the master base station and the target secondary base station.

In another embodiment of the invention, an apparatus comprises at least one processor and memory storing computer program code. The memory storing the computer program code is configured to, with the at least one processor, cause the apparatus to control a master base station to, while in communication with a user device that is in dual connectivity with the master base station and a source secondary base station, receive notification from a target secondary base station of a change request initiated by the user device and, after receiving the notification, perform changeover procedures.

In another embodiment of the invention, an apparatus comprises at least one processor and memory storing a program of instructions. The memory storing the program of instructions is configured to, with the at least one processor, cause the apparatus to at least control a secondary base station to, upon receiving a request for connection from a user device operating in dual connection with a master base station and a source secondary base station, inform the master base station of the request, and control the secondary base station to, upon initiation of connection by the user device to the secondary base station, schedule resources for use by the user device.

In another embodiment of the invention, an apparatus comprises at least one processor and memory storing a program of instructions. The memory storing the program of instructions is configured to, with the at least one processor, cause the apparatus to at least control a secondary base station having a connection to a user device operating in dual connectivity to the secondary base station and a master base station to receive a notification from the master base station of a change removing the secondary base station as a connected secondary base station for the user device, and control the secondary base station to, in response to receiving the notification, cease scheduling resources for the user device.

In another embodiment of the invention, a method comprises controlling a user device, while in dual connectivity with a master base station and a source secondary base station, to initiate a change request to a target secondary base station and, upon receiving a change authorization from the master base station, enter into dual connectivity with the master base station and the target secondary base station.

In another embodiment of the invention, a method comprises controlling a master base station to, while in communication with a user device that is in dual connectivity with the master base station and a source secondary base station, receive notification from a target secondary base station of a change request initiated by the user device and, after receiving the notification, perform changeover procedures.

In another embodiment of the invention, a method comprises controlling a secondary base station to, upon receiving a request for connection from a user device operating in dual connection with a master base station and a source secondary base station, inform the master base station of the request, and controlling the secondary base station to, upon initiation of connection by the user device to the secondary base station, schedule resources for use by the user device.

In another embodiment of the invention, a method comprises controlling a secondary base station having a connection to a user device operating in dual connectivity to the secondary base station and a master base station to receive a notification from the master base station of a change removing the secondary base station as a connected secondary base station for the user device, and control the secondary base station to, in response to receiving the notification, cease scheduling resources for the user device.

In another embodiment of the invention, a computer readable medium stores a program of instructions, execution of which by a processor configures an apparatus to at least control a user device, while in dual connectivity with a master base station and a source secondary base station, to initiate a change request to a target secondary base station and, upon receiving a change authorization from the master base station, enter into dual connectivity with the master base station and the target secondary base station.

In another embodiment of the invention, initiating the change request comprises performing a random access procedure with the target secondary base station.

In another embodiment of the invention, the apparatus is further configured to control the user device to initially listen to a physical downlink control channel of the source secondary base station and, after initiating the change request, continue to listen to the physical downlink control channel of the source secondary base station until otherwise notified.

In another embodiment of the invention, a change confirmation is received by the user device from the source secondary base station upon detection by the source secondary base station of the change request.

In another embodiment of the invention, the apparatus is further configured to control the user device to perform a random access procedure with the target secondary base station while transmission and reception of data is ongoing in parallel on the source secondary base station.

In another embodiment of the invention, an activation command for the target secondary base station is an outcome of contention resolution.

In another embodiment of the invention, a computer readable medium stores a program of instructions, execution of which by a processor configures an apparatus to control a master base station, while in communication with a user device that is in dual connectivity with the master base station and a source secondary base station, to receive notification from a target secondary base station of a change request initiated by the user device and, in response to receiving the notification, perform changeover procedures.

In another embodiment of the invention, the computer readable medium further configures the apparatus to control master base station, in response to receiving notification from the target secondary base station of the change request initiated by the user device, to notify the user device that the change request is approved.

In another embodiment of the invention, the apparatus is further configured to control the master base station to, in response to receiving notification from the target secondary base station of the change request initiated by the user device, send a deactivation message to the source secondary base station and send a message to the user device directing activation of the target secondary base station and deactivating the source secondary base station.

In another embodiment of the invention, the apparatus is further caused to control the master base station to activate data forwarding with the target secondary base station in response to deactivation of the source secondary base station and activation of the target secondary base station.

In another embodiment of the invention, signaling between the master base station and one or more of the source secondary base station and the target secondary base station is carried out using X2/Xn signaling.

In another embodiment of the invention, a computer readable medium stores a program of instructions, execution of which by a processor configures an apparatus to control a secondary base station to, upon receiving a request for connection from a user device operating in dual connection with a master base station and a source secondary base station, inform the master base station of the request, and control the secondary base station to, upon initiation of connection by the user device to the secondary base station, schedule resources for use by the user device.

In another embodiment of the invention, connection between the secondary base station and the user device is established by a random access procedure.

In another embodiment of the invention, a computer readable medium stores a program of instructions, execution of which by a processor configures an apparatus to control a secondary base station having a connection to a user device operating in dual connectivity to the secondary base station and a master base station to receive a notification from the master base station of a change removing the secondary base station as a connected secondary base station for the user device, and control the secondary base station to, in response to receiving the notification, cease scheduling resources for the user device.

In another embodiment of the invention, an apparatus comprises means for controlling a user device to, while in dual connectivity with a master base station and a source secondary base station, initiate a change request to a target secondary base station, and means for controlling the user device to, in response to receiving a change authorization from the master base station, enter into dual connectivity with the master base station and the target secondary base station.

In another embodiment of the invention, initiating the change request comprises performing a random access procedure with the target secondary base station.

In another embodiment of the invention the apparatus further comprises means for controlling the user device to initially listen to a physical downlink control channel of the source secondary base station and, after initiating the change request, continue to listen to the physical downlink control channel of the source secondary base station until otherwise notified.

In another embodiment of the invention, a change confirmation is received by the user device from the source secondary base station upon detection by the source secondary base station of the change request.

In another embodiment of the invention, the apparatus further comprises means for controlling the user device to perform a random access procedure with the target secondary base station while transmission and reception of data is ongoing in parallel on the source secondary base station.

In another embodiment of the invention, an activation command for the target secondary base station is an outcome of contention resolution.

In another embodiment of the invention, an apparatus comprises means for controlling a master base station to, while in communication with a user device that is in dual connectivity with the master base station and a source secondary base station, receive notification from a target secondary base station of a change request initiated by the user device, and means for controlling the master base station to, in response to receiving the notification, perform changeover procedures.

In another embodiment of the invention, the apparatus further comprises means for controlling the master base station to, in response to receiving notification from the target secondary base station of the change request initiated by the user device, notify the user device that the change request is approved.

In another embodiment of the invention, the apparatus further comprises means for controlling the master base station to, in response to receiving notification from the target secondary base station of the change request initiated by the user device, send a deactivation message to the source secondary base station, and controlling the master base station to send a message to the user device directing activation of the target secondary base station and deactivating the source secondary base station.

In another embodiment of the invention, the apparatus further comprises means for controlling the master base station to activate data forwarding with the target secondary base station in response to deactivation of the source secondary base station and activation of the target secondary base station.

In another embodiment of the invention, signaling between the master base station and one or more of the source secondary base station and the target secondary base station is carried out using X2/Xn signaling.

In another embodiment of the invention, an apparatus comprises controlling a secondary base station to, upon receiving a request for connection from a user device operating in dual connection with a master base station and a source secondary base station, inform the master base station of the request, and means for controlling the secondary base station to, upon initiation of connection by the user device to the secondary base station, schedule resources for use by the user device.

In another embodiment of the invention, connection between the secondary base station and the user device is established by a random access procedure.

In another embodiment of the invention, an apparatus comprises means for controlling a secondary base station having a connection to a user device operating in dual connectivity to the secondary base station and a master base station to receive a notification from the master base station of a change removing the secondary base station as a connected secondary base station for the user device, and means for controlling the secondary base station to, in response to receiving the notification, cease scheduling resources for the user device.

### BRIEF DESCRIPTION OF THE DRAWINGS

FIG. 1 illustrates a network employing an embodiment of the present invention;

FIG. 2 illustrates a process according to an embodiment of the present invention;

FIGS. 3 and 4 illustrate signaling and operation diagrams according to embodiments of the present invention; and

FIG. 5 illustrates elements that may be used in carrying out embodiments of the present invention.

### DETAILED DESCRIPTION

Embodiments of the present invention address the selection of SeNBs by a UE for autonomous small cell mobility, encompassing dual connectivity. The UE is allowed to directly access pre-configured SeNBs using appropriately allocated resources with no need for signaling exchange with the network (represented, for example, by the MeNB). For example, RRM measurement reports from the UE to the network, or handover commands from the network to the UE, may be avoided.

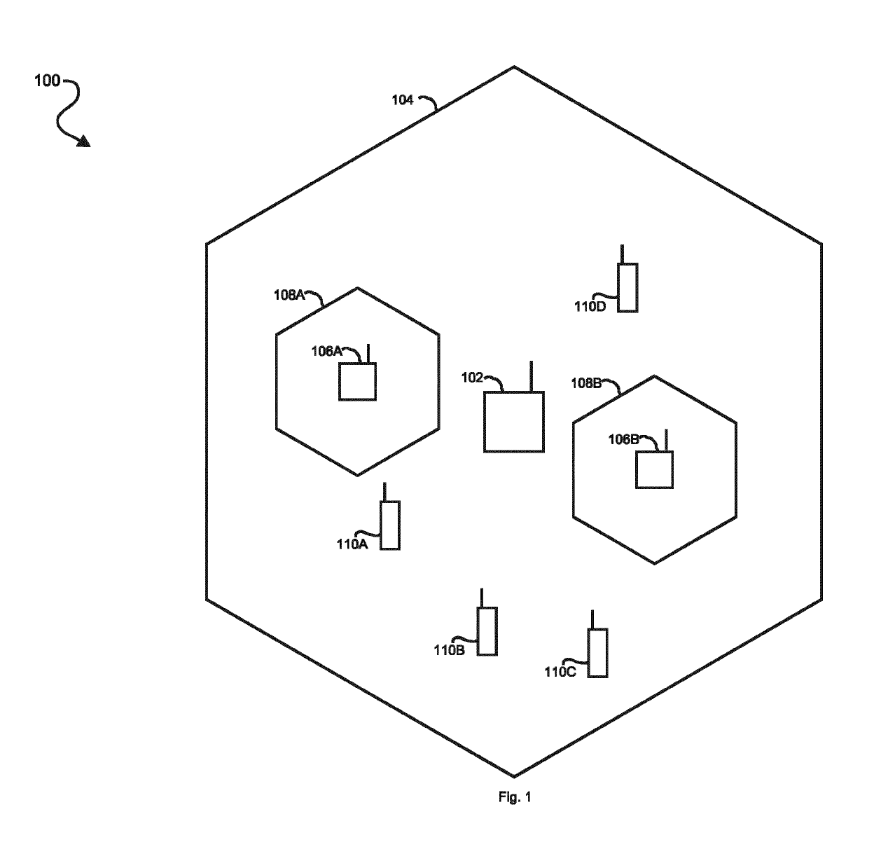

FIG. 1 illustrates a network 100 according to an embodiment of the present invention. The network 100 comprises a master eNB 102 defining a primary cell 104, and exemplary secondary eNBs (SeNBs) 106A and 106B, defining secondary cell coverage areas 108A and 108B. The network supports UEs such as the UEs 110A-110D. A UE, such as the UE 110A, may be in dual connectivity with the MeNB 102 and an SeNB such as the SeNB 106A. The UE 110A may then undergo a connection change, dropping its connection to the SeNB 108A and connecting to the SeNB 108B. Embodiments of the present invention provide mechanisms for reducing or eliminating unnecessary signaling by an initially connected SeNB (which may be referred to as a source SeNB) when a UE drops its connection with the source eNB in order to connect to a different SeNB (suitably referred to as a target SeNB). Once a UE gains access to a target SeNB, there is no need for the source SeNB to continue to schedule uplink (UL) and downlink (DL) resources, but if the UE communicates with the target SeNB too early (for example, listening to the physical downlink control channel (PDCCH) of the target SeNB), just after making a change request, capacity of the source SeNB may be reduced and the source SeNB may also cause unnecessary DL interference. In one or more embodiments of the present invention, a UE may initially be in dual connectivity with the MeNB on a first frequency (F1) and a first SeNB.

Suppose, then, as noted above, that the UE 110A undergoes a connection change, dropping its connection to the SeNB 106A and connecting to the SeNB 106B. This process begins with a transmission by the UE 110A of an access request to the SeNB (106B) (which in this scenario is the target SeNB).

Embodiments of the present invention address mechanisms to inform the UE of successful connectivity between the UE and a target SeNB. Confirmation of a successful autonomous SeNB change may come from the MeNB or from an SeNB, and the UE continues attachment to the source SeNB (listening to the PDCCH on the source SeNB) until it receives the confirmation of a successful autonomous SeNB change. At that point, the UE can begin listening to the PDCCH on the target SeNB, and being scheduled on the target SeNB. The UE may perform random access channel (RACH) procedures on the target SeNB while data transmission and reception is ongoing in parallel on the source SeNB on the same or a different carrier frequency. Timing advance information that may be acquired by the UE during the access procedure to the target eNB will generally still be valid when the UE receives a message confirming successful autonomous SeNB change, so that the UE can generally begin listening for potential allocations on the target SeNB and transmit in uplink towards the target SeNB without acquiring new time advance information - for example, requiring a new RACH procedure.

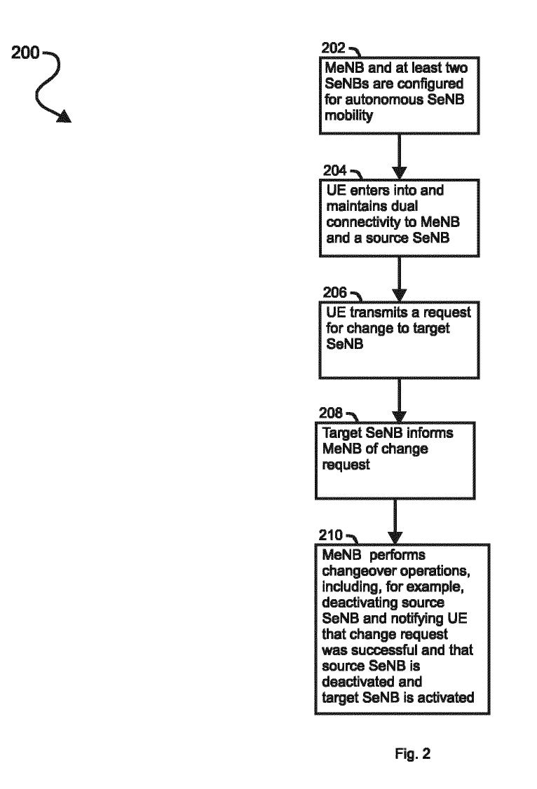

FIG. 2 illustrates a process 200 according to an embodiment of the present invention. At block 202, an MeNB and at least two SeNBs are configured for autonomous SeNB mobility. Such a configuration may specify mechanisms for dual connectivity of a UE to the MeNB and an SeNB, and handover between SeNBs or other changes in connectivity of the UE between one SeNB and another. An SeNB to which a UE is initially connected may be conveniently referred to as a source SeNB and an SeNB which is to replace the source SeNB in the connection may be referred to as a target SeNB.

At block 204, the UE enters into and maintains dual connectivity operation with the MeNB and a source SeNB. At block 206, based on measurements or other detection of conditions affecting the UE's connection with the network, the UE selects the target SeNB and transmits a request for change to the target SeNB. At block 208, the target SeNB informs the MeNB of the received change request. At block 210, the MeNB performs changeover operations. In one or more embodiments, the changeover operations may be performed in parallel, or in one sequence or another, with the sequence in which the operations are undertaken being a matter of choice and not restricted to the present order of presentation. The operations may include:
The MeNB notifies the source SeNB that it is no longer an activated or configured SeNB for the specified UE.
The source SeNB ceases to schedule resources to the UE. The MeNB signals a confirmation message to the UE, indicating successful autonomous SeNB change.
The MeNB begins to redirect user plane data to the target SeNB. Such redirection may also serve to indicate that the corresponding connection between the SeNB and the UE has been activated.

In one or more embodiments of the invention, the confirmation message from the MeNB is transmitted using a media access control (MAC) element that at the same time activates the SCell corresponding to the target SeNB and deactivates the SCell corresponding to the source SeNB. In another exemplary embodiment of the invention, confirmation of a successful autonomous SeNB change is signaled via a radio resource control (RRC) reconfiguration message (potentially followed by a MAC activation message for the newly configured SeNB/SCell). If the confirmation is sent via RRC, the MeNB can also configure dedicated PUCCH resources on the newly configured SeNB/SCell. Such resources may, in one or more embodiments of the invention, be specified when the target SeNB sends the SCell change message to MeNB. Such an approach avoids a need for PUCCH resource reservation at the time that small eNBs are configured so as to serve as potential dual connectivity SeNBs defining SCells. Only RACH related parameters and a cell radio network temporary identifier (C-RNTI) are required to be pre-configured at the potential SCells. Such an approach avoids a need for the UE to make a measurement report to the MeNB and for the MeNB to make a handover request to the target SeNB, and for the UE to perform a contention free RACH process at the UE to the target SeNB after receiving the handover command from the MeNB. Instead, the UE may simply perform an autonomous contention-based RACH procedure directly to the target eNB.

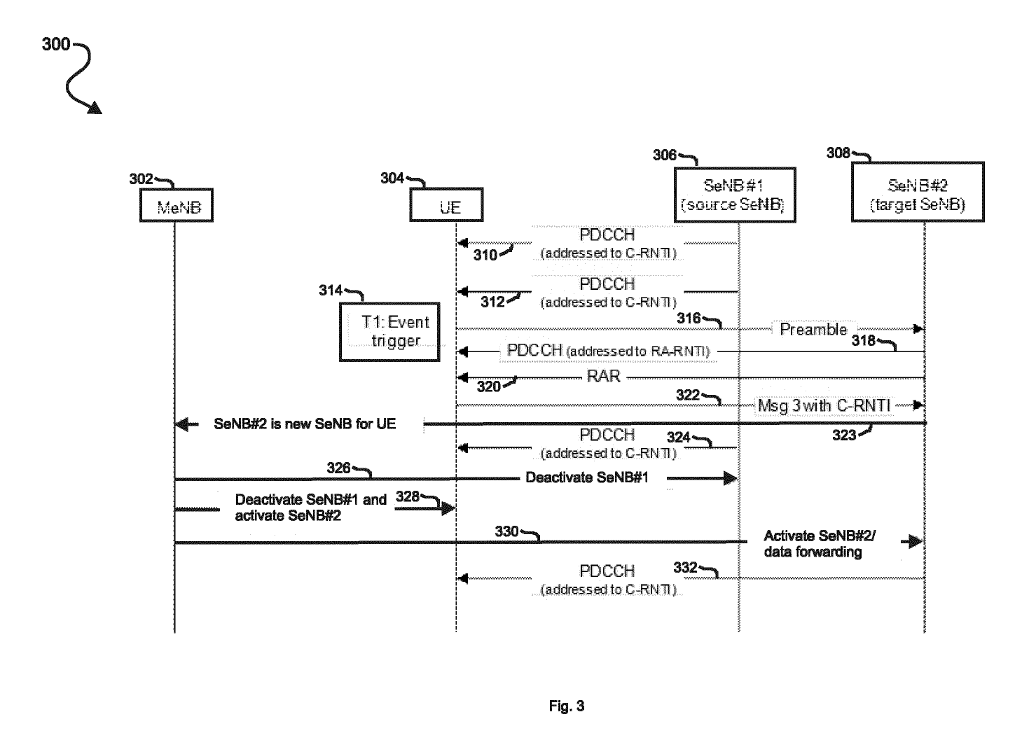

FIG. 3 illustrates a diagram 300 illustrating signaling and procedures for SeNB change according to an embodiment of the present invention. Signaling is carried out between, and procedures are carried out by, an MeNB 302, a UE 304, a source SeNB 306, and a target SeNB 308.

Initially, the source SeNB 306 periodically provides PDCCH signaling (illustrated here as PDCCH 310 and PDCCH 312) to the C-RNTI of the UE 304. At a triggering event 314, the UE initiates an access request, suitably in the form of a message preamble 316, to the target SeNB 308. The target SeNB 308 responds by sending a PDCCH 318 addressed to a random access RNTI and a random access response (RAR) 320. The UE sends a message 3 signal 322, including its C-RNTI, to the target SeNB 308, and the target SeNB 308 sends to the MeNB 302 a message 323 indicating that the target SeNB 308 is the new SeNB for the UE 304. The source SeNB 306, because it has not yet received a notification, provides PDCCH 324 to the UE. The MeNB 302, however, sends a deactivation signal 326 to the source SeNB, after which the source SeNB 306 no longer sends PDCCH signaling to the UE 304. The MeNB 302 also sends a signal 328 to the UE, instructing the UE to deactivate the source SeNB and activate the target SeNB. The MeNB sends an activation signal 330 to the target SeNB 308, and the target SeNB 308 thereafter provides PDCCH signaling to the UE 204 (exemplified here by the PDCCH signal 332).

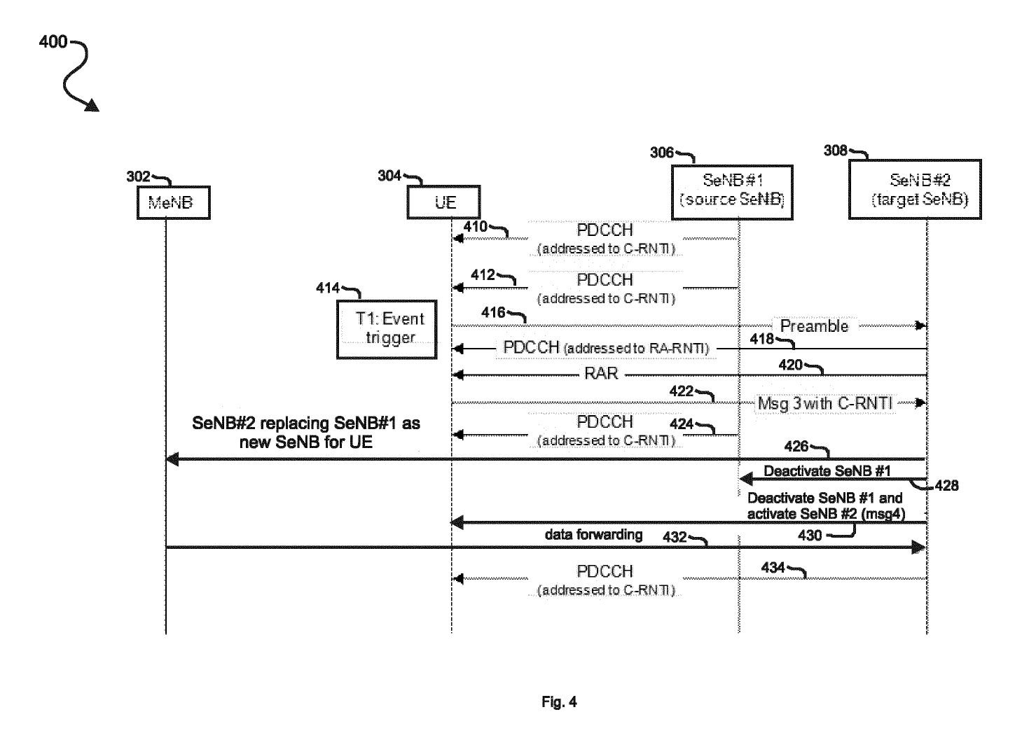

FIG. 4 illustrates a diagram 400 illustrating another embodiment of the present invention. Signaling is again carried out between, and procedures are carried out by, an MeNB 302, a UE 304, a source SeNB 306, and a target SeNB 308.

Initially, the SeNB 306 periodically provides PDCCH signaling (illustrated here as PDCCH 410 and PDCCH 412) to the C-RNTI of the UE 304. At a triggering event 414, the UE initiates an access request, suitably in the form of a message preamble 416, to the target SeNB 308 and the target SeNB 308 responds by sending a PDCCH 418 addressed to a random access RNTI and also sends a random access response (RAR) 420. The UE sends a message 3 signal 422, including its C-RNTI, to the target SeNB 308. The source SeNB 306, because it has not yet received a notification, provides PDCCH 424 to the UE. In the exemplary embodiment described here, the target SeNB 308 sends a notification 426 to the MeNB 302 that the target SeNB 308 is replacing the source SeNB 306 as the SeNB for the UE 304. The target SeNB 308 sends a deactivation message 428 to the source SeNB 306, as well as a deactivation/activation message 430. The deactivation/activation message 430 may be in (msg 4) format and may provide notification to the UE 302 that the source SeNB is to be deactivated and the target SeNB 308 is to be activated. The MeNB 302 performs data forwarding 432 to the target SeNB 308, and the target SeNB 308 initiates sending of a PDCCH, in this case, as a PDCCH signal 434, addressing the PDCCH signal 434 to the C-RNTI of the UE 304.

In one or more embodiments of the invention, a source SeNB is able to detect a change request message as it is directed to the target SeNB by the UE. If the source SeNB is able to detect the change request message, it can send its own confirmation to the UE without a need to wait for the target SeNB or the MeNB to relay the information that a change request has been made.

One or more alternative or additional embodiments provide mechanisms for SeNB/SCell addition and removal procedures. In such cases, the UE sends an autonomous request for SeNB/SCell addition/removal to the SeNB, the SeNB informs the MeNB using X2/Xn signaling, and the MeNB signals a confirmation message (activation/deactivation message or in some possible implementations an RRC reconfiguration message) to confirm to the UE that the SeNB/SCell addition/removal procedure has been completed.

The UE is able to perform a RACH procedure on the target

SeNB/SCell while the target SeNB/Cell is not yet activated as an SeNB for the UE, while data transmission/reception is ongoing in parallel on the source SeNB/SCell (on the same carrier frequency). Embodiments of the present invention provide for random access channel procedures on a deactivated cell and contention based random access channel procedures on an SCell.

In one or more embodiments of the invention, an activation command for the target SeNB/SCell may be an outcome of contention resolution. Other outcomes of contention resolution may be, for example, the PDCCH from the target SeNB/SCell after the SeNB receives confirmation from the MeNB, or the PDCCH from the target cell upon reception of a message 3 to stop the RACH. The PDDCH from the target cell may include an activation message media access control element (as included, for example, in the message 430 of FIG. 4).

Embodiments of the present invention provide for various mechanisms to address considerations affecting uplink transmission. The UE generally cannot simultaneously transmit to both SeNBs/SCells. Therefore, in one or more embodiments of the invention, it may prioritize preamble and message 3 transmission to the target SeNB/SCell over uplink data and control transmissions (an example of control transmissions being ACK/NACK) to the source SeNB/SCell. If the UE is not able to transmit on both carrier frequencies, it should prioritize preamble and message 3 transmission towards the target SeNB over UL data and control transmission towards the MeNB.

If the UE is still considered to be connected to the source SeNB before the confirmation message is received, it still follows the UL grant from the source SeNB (if any) even after receiving the RAR from the target SeNB. In this case the UE still needs to apply the TA for the source SeNB, which means the UE must store two TAs for the same carrier frequency during the period.

Embodiments of the invention also provide mechanisms addressing aspects of downlink transmission.

The UE suitably prioritizes RAR and contention resolution reception on the target SeNB over DL data reception on the source SeNB for example, monitoring PDCCH on the target SeNB but not on the source SeNB within the RAR window until RAR is received or when the contention resolution timer is running. Alternatively or in addition, the UE is capable of receiving PDCCH on both target and source SeNB and prioritizing processing RAR/contention resolution over data if both are received in the same transmission time interval (TTI). In alternative or additional embodiments of the invention, the UE may process PDCCH and PDSCH for both RAR/contention resolution and data.

If the activation MAC CE from the MeNB is considered as contention resolution, the UE does not need to monitor PDCCH on target SeNB for contention resolution after msg3 transmission. Preamble transmission re-attempts may be made when a contention resolution timer expires.

Embodiments of the present invention have the effect of reducing or eliminating potential capacity loss at the source SeNB (and unnecessary DL interference generated by the source SeNB) and timing ambiguity between UE and eNB about activated serving cells in cases the source eNB is not able to detect the autonomous SeNB change request transmitted by the UE towards the target SeNB. In some embodiments, a UE may need to wait for a confirmation message transmitted by an assisting MeNB (or, in one or more alternative or additional embodiments, from the source SeNB) before being scheduled for data on the target SeNB. Such a delay might depend on the X2/Xn delay (time needed by the target SeNB to inform the MeNB, and by the MeNB to send the confirmation message to the UE). However, even if the UE starts listening to the PDCCH on the target SeNB just after sending the SeNB/SCell change request, the target SeNB will still need some time (also depending on the X2/Xn delay) before it can fetch data from the MeNB and start scheduling the corresponding UE (at least for DL traffic). So in practice the additional delay introduced by the proposed invention might only represent an issue for UL traffic.

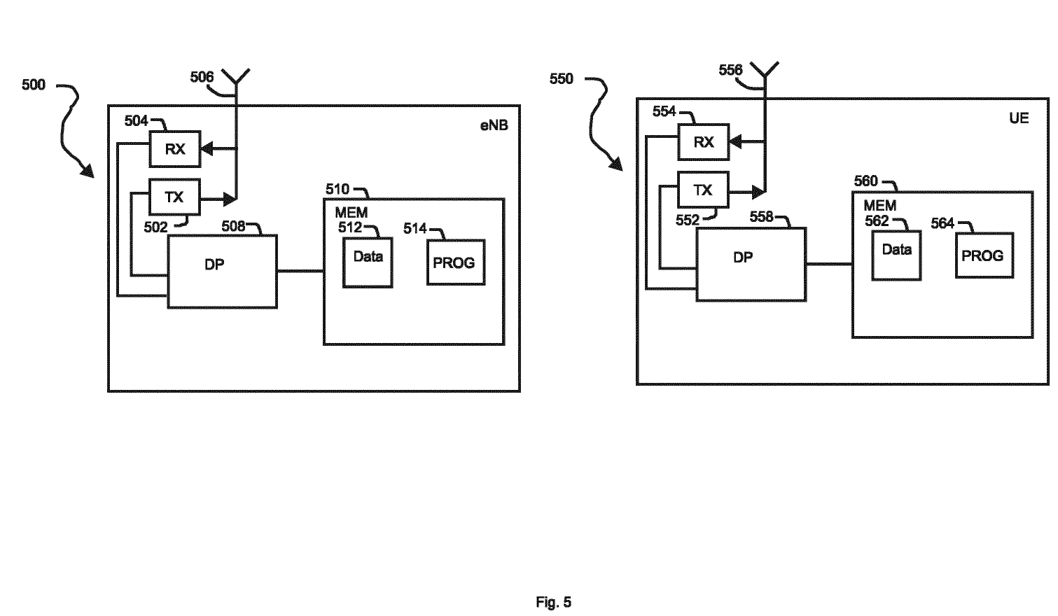

FIG. 5 illustrates details of a base station, implemented as an eNB 500, and a mobile communications device, implemented as a UE 550. An MeNB such as the MeNBs 102 or 202, or an SeNB such as the SeNBs 106A, 106B, or 206, may be implemented using an eNB such as the eNB 500. The eNB 500 may suitably comprise a transmitter 502, receiver 504, and antenna 506. The eNB 500 may also include a processor 508 and memory 510. The eNB 500 may employ data 512 and programs (PROGS) 514, residing in memory 510.

The UE 550 may suitably comprise a transmitter 552, receiver 554, and antenna 556. The UE 550 may also include a processor 558 and memory 560. The UE 550 may employ data 562 and programs (PROGS) 564, residing in memory 560.

At least one of the PROGs 514 in the eNB 500 is assumed to include a set of program instructions that, when executed by the associated DP 508, enable the device to operate in accordance with the exemplary embodiments of this invention, as detailed above. In these regards the exemplary embodiments of this invention may be implemented at least in part by computer software stored on the MEM 510, which is executable by the DP 508 of the eNB 500, or by hardware, or by a combination of tangibly stored software and hardware (and tangibly stored firmware). Similarly, at least one of the PROGs 564 in the UE 550 is assumed to include a set of program instructions that, when executed by the associated DP 558, enable the device to operate in accordance with the exemplary embodiments of this invention, as detailed above. In these regards the exemplary embodiments of this invention may be implemented at least in part by computer software stored on the MEM 560, which is executable by the DP 558 of the UE 550, or by hardware, or by a combination of tangibly stored software and hardware (and tangibly stored firmware). Electronic devices implementing these aspects of the invention need not be the entire devices as depicted at FIG. 1 or FIG. 5 or may be one or more components of same such as the above described tangibly stored software, hardware, firmware and DP, or a system on a chip SOC or an application specific integrated circuit ASIC.

In general, the various embodiments of the UE 550 can include, but are not limited to personal portable digital devices having wireless communication capabilities, including but not limited to cellular telephones, navigation devices, laptop/palmtop/tablet computers, digital cameras and music devices, and Internet appliances.

Various embodiments of the computer readable MEM 510 and 560 include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DP 508 and 558 include but are not limited to general purpose computers, special purpose computers, microprocessors, digital signal processors (DSPs) and multi-core processors.

Electronic devices implementing these aspects of the invention need not be the entire devices as depicted at FIG. 1 or FIG. 5 or may be one or more components of same such as the above described tangibly stored software, hardware, firmware and DP, or a system on a chip SOC or an application specific integrated circuit ASIC.

In an embodiment of the invention, a user device comprises at least one processor and memory storing computer program code. The memory storing the computer program code is configured to, with the at least one processor, cause the user device, while in dual connectivity with a master base station and a source secondary base station, to initiate a change request to a target secondary base station and, upon receiving a change authorization from the master base station, enter into dual connectivity with the master base station and the target secondary base station.

In another embodiment of the invention, initiating the change request comprises performing a random access procedure with the target secondary base station.

In another embodiment of the invention, the user device initially listens to a physical downlink control channel of the source secondary base station and, after initiating the change request, continues to listen to the physical downlink control channel of the source secondary base station until otherwise notified.

In another embodiment of the invention, a master base station comprises at least one processor and memory storing computer program code. The memory storing the computer program code is configured to, with the at least one processor, cause the master base station, while in communication with a user device that is in dual connectivity with the master base station and a source secondary base station, receive notification from a target secondary base station of a change request initiated by the user device and, after receiving the notification, perform changeover procedures.

In another embodiment of the invention, the master base station, in response to receiving notification from the target secondary base station of the change request initiated by the user device, notifies the user device that the change request is approved.

In another embodiment of the invention, the master base station, in response to receiving notification from the target secondary base station of the change request initiated by the user device, sends a deactivation message to the source secondary base station and sends a message to the user device activating the target secondary base station and deactivating the source secondary base station.

In another embodiment of the invention, the master base station activates data forwarding with the target secondary base station in response to deactivation of the source secondary base station and activation of the target secondary base station.

In another embodiment of the invention, signaling between the master base station and one or more of the source secondary base station and the target secondary base station is carried out using X2/Xn signaling.

In another embodiment of the invention, a method comprises causing a user device, while in dual connectivity with a master base station and a source secondary base station, to initiate a change request to a target secondary base station and, upon receiving a change authorization from the master base station, enter into dual connectivity with the master base station and the target secondary base station.

In another embodiment of the invention, a method comprises causing a master base station, while in communication with a user device that is in dual connectivity with the master base station and a source secondary base station, to receive notification from a target secondary base station of a change request initiated by the user device and, after receiving the notification, perform changeover procedures.

In another embodiment of the invention, the method comprises causing the master base station, in response to receiving notification from the target secondary base station of the change request initiated by the user device, to notify the user device that the change request is approved.

In another embodiment of the invention, a computer readable medium stores a program of instructions, execution of which by a processor configures an apparatus to at least control a user device, while in dual connectivity with a master base station and a source secondary base station, to initiate a change request to a target secondary base station and, upon receiving a change authorization from the master base station, enter into dual connectivity with the master base station and the target secondary base station.

In another embodiment of the invention, initiating the change request comprises performing a random access procedure with the target secondary base station.

In another embodiment of the invention, the apparatus is further configured to control the user device to initially listen to a physical downlink control channel of the source secondary base station and, after initiating the change request, continue to listen to the physical downlink control channel of the source secondary base station until otherwise notified.

In another embodiment of the invention, a change confirmation is received by the user device from the source secondary base station upon detection by the source secondary base station of the change request.

In another embodiment of the invention, the apparatus is further configured to control the user device to perform a random access procedure with the target secondary base station while transmission and reception of data is ongoing in parallel on the source secondary base station.

In another embodiment of the invention, an activation command for the target secondary base station is an outcome of contention resolution.

In another embodiment of the invention, a computer readable medium stores a program of instructions, execution of which by a processor configures an apparatus to control a master base station, while in communication with a user device that is in dual connectivity with the master base station and a source secondary base station, to receive notification from a target secondary base station of a change request initiated by the user device and, in response to receiving the notification, perform changeover procedures.

In another embodiment of the invention, the computer readable medium further configures the apparatus to control master base station, in response to receiving notification from the target secondary base station of the change request initiated by the user device, to notify the user device that the change request is approved.

In another embodiment of the invention, the apparatus is further configured to control the master base station to, in response to receiving notification from the target secondary base station of the change request initiated by the user device, send a deactivation message to the source secondary base station and send a message to the user device directing activation of the target secondary base station and deactivating the source secondary base station.

In another embodiment of the invention, the apparatus is further caused to control the master base station to activate data forwarding with the target secondary base station in response to deactivation of the source secondary base station and activation of the target secondary base station.

In another embodiment of the invention, signaling between the master base station and one or more of the source secondary base station and the target secondary base station is carried out using X2/Xn signaling.

In another embodiment of the invention, a computer readable medium stores a program of instructions, execution of which by a processor configures an apparatus to control a secondary base station to, upon receiving a request for connection from a user device operating in dual connection with a master base station and a source secondary base station, inform the master base station of the request, and control the secondary base station to, upon initiation of connection by the user device to the secondary base station, schedule resources for use by the user device.

In another embodiment of the invention, connection between the secondary base station and the user device is established by a random access procedure.

In another embodiment of the invention, a computer readable medium stores a program of instructions, execution of which by a processor configures an apparatus to control a secondary base station having a connection to a user device operating in dual connectivity to the secondary base station and a master base station to receive a notification from the master base station of a change removing the secondary base station as a connected secondary base station for the user device, and control the secondary base station to, in response to receiving the notification, cease scheduling resources for the user device.

In another embodiment of the invention, an apparatus comprises means for controlling a user device to, while in dual connectivity with a master base station and a source secondary base station, initiate a change request to a target secondary base station, and means for controlling the user device to, in response to receiving a change authorization from the master base station, enter into dual connectivity with the master base station and the target secondary base station.

In another embodiment of the invention, initiating the change request comprises performing a random access procedure with the target secondary base station.

In another embodiment of the invention the apparatus further comprises means for controlling the user device to initially listen to a physical downlink control channel of the source secondary base station and, after initiating the change request, continue to listen to the physical downlink control channel of the source secondary base station until otherwise notified.

In another embodiment of the invention, a change confirmation is received by the user device from the source secondary base station upon detection by the source secondary base station of the change request.

In another embodiment of the invention, the apparatus further comprises means for controlling the user device to perform a random access procedure with the target secondary base station while transmission and reception of data is ongoing in parallel on the source secondary base station.

In another embodiment of the invention, an activation command for the target secondary base station is an outcome of contention resolution.

In another embodiment of the invention, an apparatus comprises means for controlling a master base station to, while in communication with a user device that is in dual connectivity with the master base station and a source secondary base station, receive notification from a target secondary base station of a change request initiated by the user device, and means for controlling the master base station to, in response to receiving the notification, perform changeover procedures.

In another embodiment of the invention, the apparatus further comprises means for controlling the master base station to, in response to receiving notification from the target secondary base station of the change request initiated by the user device, notify the user device that the change request is approved.

In another embodiment of the invention, the apparatus further comprises means for controlling the master base station to, in response to receiving notification from the target secondary base station of the change request initiated by the user device, send a deactivation message to the source secondary base station, and controlling the master base station to send a message to the user device directing activation of the target secondary base station and deactivating the source secondary base station.

In another embodiment of the invention, the apparatus further comprises means for controlling the master base station to activate data forwarding with the target secondary base station in response to deactivation of the source secondary base station and activation of the target secondary base station.

In another embodiment of the invention, signaling between the master base station and one or more of the source secondary base station and the target secondary base station is carried out using X2/Xn signaling.

In another embodiment of the invention, an apparatus comprises controlling a secondary base station to, upon receiving a request for connection from a user device operating in dual connection with a master base station and a source secondary base station, inform the master base station of the request, and means for controlling the secondary base station to, upon initiation of connection by the user device to the secondary base station, schedule resources for use by the user device.

In another embodiment of the invention, connection between the secondary base station and the user device is established by a random access procedure.

In another embodiment of the invention, an apparatus comprises means for controlling a secondary base station having a connection to a user device operating in dual connectivity to the secondary base station and a master base station to receive a notification from the master base station of a change removing the secondary base station as a connected secondary base station for the user device, and means for controlling the secondary base station to, in response to receiving the notification, cease scheduling resources for the user device.

While various exemplary embodiments have been described above it should be appreciated that the practice of the invention is not limited to the exemplary embodiments shown and discussed here. Various modifications and adaptations to the foregoing exemplary embodiments of this invention may become apparent to those skilled in the relevant arts in view of the foregoing description. It will be further recognized that various blocks discussed above may be performed as steps, but the order in which they are presented is not limiting and they may be performed in any appropriate order with or without additional intervening blocks or steps.

Further, some of the various features of the above non-limiting embodiments may be used to advantage without the corresponding use of other described features.

The foregoing description should therefore be considered as merely illustrative of the principles, teachings and exemplary embodiments of this invention, and not in limitation thereof.

1. An apparatus comprising:
at least one processor;
memory storing computer program code;
wherein the memory storing the computer program code is configured to, with the at least one processor, cause the apparatus to at least:
control a user device to, while in dual connectivity with a master base station and a source secondary base station, initiate a change request to a target secondary base station; and control the user device to, in response to receiving a change authorization from the master base station, enter into dual connectivity with the master base station and the target secondary base station.

2. The apparatus of claim 1, wherein initiating the change request comprises performing a random access procedure with the target secondary base station.

3. The apparatus of claim 1, wherein the apparatus is further caused to control the user device to initially listen to a physical downlink control channel of the source secondary base station and, after initiating the change request, continue to listen to the physical downlink control channel of the source secondary base station until otherwise notified.

4. The apparatus of claim 1, wherein a change confirmation is received by the user device from the source secondary base station upon detection by the source secondary base station of the change request.

5. The apparatus of claim 2, wherein the apparatus is further caused to control the user device to perform a random access procedure with the target secondary base station while transmission and reception of data is ongoing in parallel on the source secondary base station.

6. The apparatus of any of claim 1, wherein an activation command for the target secondary base station is an outcome of contention resolution.

7. An apparatus comprising:
at least one processor;
memory storing a program of instructions;
wherein the memory storing the a program of instructions is configured to, with the at least one processor, cause the apparatus to at least:
control a base station to, while in communication with a user device that is in dual connectivity with the base station and a source secondary base station, receive notification from a target secondary base station of a change reguest initiated by the user device; and
in response to receiving the notification, perform changeover procedures.

8. The apparatus of claim 7, wherein the apparatus is further caused to control the master base station to, in response to receiving notification from the target secondary base station of the change request initiated by the user device, notify the user device that the change request is approved.

9. The apparatus of claim 7, wherein the apparatus is further caused to control the master base station to, in response to receiving notification from the target secondary base station of the change request initiated by the user device, send a deactivation message to the source secondary base station; and
send a message to the user device directing activation of the target secondary base station, deactivating the source secondary base station and in response to this activating data forwarding with the target secondary base station.

10. (canceled)

11. The apparatus of claim 9, wherein signaling between the master base station and one or more of the source secondary base station and the target secondary base station is carried out using X2/Xn signaling.

12.-14. (canceled)

15. A method comprising:
controlling a user device to, while in dual connectivity with a master base station and a source secondary base station, initiate a change request to a target secondary base station; and
controlling the user device to, in response to receiving a change authorization from the master base station, enter into dual connectivity with the master base station and the target secondary base station.

16. The method of claim 15, wherein initiating the change request comprises performing a random access procedure with the target secondary base station.

17. The method of claim 15, further comprising controlling the user device to initially listen to a physical downlink control channel of the source secondary base station and, after initiating the change request, continue to listen to the physical downlink control channel of the source secondary base station until otherwise notified.

18. The method of claim 15, wherein a change confirmation is received by the user device from the source secondary base station upon detection by the source secondary base station of the change request.

19. The method of claim 16, further comprising controlling the user device to perform a random access procedure with the target secondary base station while transmission and reception of data is ongoing in parallel on the source secondary base station.

20. The method of claim 15, wherein an activation command for the target secondary base station is an outcome of contention resolution.

21. A method comprising:
controlling a master base station to, while in communication with a user device that is in dual connectivity with the master base station and a source secondary base station, receive notification from a target secondary base station of a change request initiated by the user device; and
in response to receiving the notification, perform changeover procedures.

22. The method of claim 21, further comprising controlling the master base station to, in response to receiving notification from the target secondary base station of the change request initiated by the user device, notify the user device that the change request is approved.

23. The method of claim 21, further comprising controlling the master base station to, in response to receiving notification from the target secondary base station of the change request initiated by the user device, send a deactivation message to the source secondary base station, and controlling the master base station to send a message to the user device directing activation of the target secondary base station, deactivating the source secondary base station and in response to this activating data forwarding with the target secondary base station.

24. (canceled)

25. The method of claim 23, wherein signaling between the master base station and one or more of the source secondary base station and the target secondary base station is carried out using X2/Xn signaling.

26.-28. (canceled)
